(19) United States
(12) Patent Application Publication
(10) Pub. No.: US 2007/0172387 A1
(43) Pub. Date: Jul. 26, 2007

(54) Housing panel structure for an analytical instrument

(76) Inventors: Wei-Liang Song, Shanghai (CN); Dexiang Cao, Shanghai (CN)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/395,748

(22) Filed: Mar. 30, 2006

(30) Foreign Application Priority Data
Jan. 26, 2006 (CN) 200610003025.2

(51) Int. Cl. G01N 31/22

(52) U.S. Cl. 422/58

(57) ABSTRACT

An analytical instrument includes an instrument body having a multiple external-device interfaces for connection with external devices, and a housing that covers the instrument body. The housing includes a housing panel having a first opening exposing the external-device interfaces and a plug structure having a first plug and a second plug. The first plug rotatably fits into the first opening and includes a second opening that exposes one of the external-device interfaces. The second plug is smaller than the first plug and is removably fitted into the second opening to close the second opening when no external device is connected to any of the external-device interfaces. When an external device is to connect to one of the external-device interfaces, the second plug is removed from the second opening and the first plug is rotated to expose the intended one of the external-device interface through the second opening.

### TECHNICAL FIELD

The present invention relates generally to an analytical instrument. More specifically, the present invention relates to an improved housing panel structure for an analytical instrument having multiple external-device interfaces.

### BACKGROUND

An analytical instrument generally includes an instrument body and housing for covering the instrument body. The term “body” as used herein means the operating unit of the instrument. The instrument body typically includes multiple external-device interfaces to connect with external devices.

Gas Chromatography (GC) is a kind of analytical instrument used for separating a mixture of compounds. A mass-spectrometer or atomic emission detector, as an external device to the GC, can be connected to the GC for performing special analyses (e.g., identification) on the compounds separated by the GC. A GC typically includes a GC body having a sample injection port, a GC column, and an oven for heating the GC column. The GC also includes housing for covering the GC body. For connection with the external devices, multiple external-device interfaces are provided on the GC body and a number of holes or openings are correspondingly provided on the housing to expose the external-device interfaces for external access. FIG. 1 shows one such prior art arrangement, which will be described in more detail below.

As shown in FIG. 1, a housing panel 100 for a GC includes two openings 101 and 102 to expose the external-device interfaces (both not shown) on the GC body of the GC. In order to prevent contaminants from entering into the GC body, two plugs or covers 111 and 112 are used to cover the openings 101 and 102 when there is no external device connected to the GC.

With the development of new technology and applications, more and more new external devices need to be connected to a GC. For example, when an additional mass spectrometer is required to connect with the GC when both of the external-device interfaces are occupied by their respective external devices, an additional external-device interface is needed, and an additional opening is also correspondingly needed on the housing. FIG. 2 is a front view of the housing panel 100 shown in FIG. 1, in which an additional opening 103 (shown in dashed line) is provided for exposing the additional external-device interface.

As shown in FIG. 2, the opening 103 overlaps, in part, with the two original openings 101 and 102, and thus a standard plug (e.g., plug 111 or 112 in FIG. 1) cannot be used to cover the opening 103 and a specially-shaped plug is required. This means that there will be several matching plugs of varying sizes and shapes for covering the openings, thus making the operation inconvenient and increasing the manufacturing cost of the GC.

### SUMMARY

In accordance with one embodiment of the present invention, an analytical instrument includes an instrument body having external-device interfaces for connection with external devices, and a housing to cover the instrument body. The housing includes a housing panel having a first opening that exposes all of the external-device interfaces. The analytical instrument further includes a plug structure having a first plug and a second plug. The first plug rotatably fits into the first opening and includes a second opening that exposes one of the external-device interfaces. The second plug is smaller than the first plug and is removably fitted into the second opening to close the second opening when no external device is connected to the external-device interfaces. When an external device is to connect to one of the external-device interfaces, the second plug is removed from the second opening and the first plug is rotated to expose the intended external-device interface through the second opening.

### BRIEF DESCRIPTION OF THE DRAWINGS

The accompanying drawings, which are incorporated in and form a part of this specification, illustrate an embodiment of the invention and, together with the description, serve to explain the principles of the invention. In the drawings:

FIG. 1 is an exploded perspective view showing the housing panel of a prior art GC;

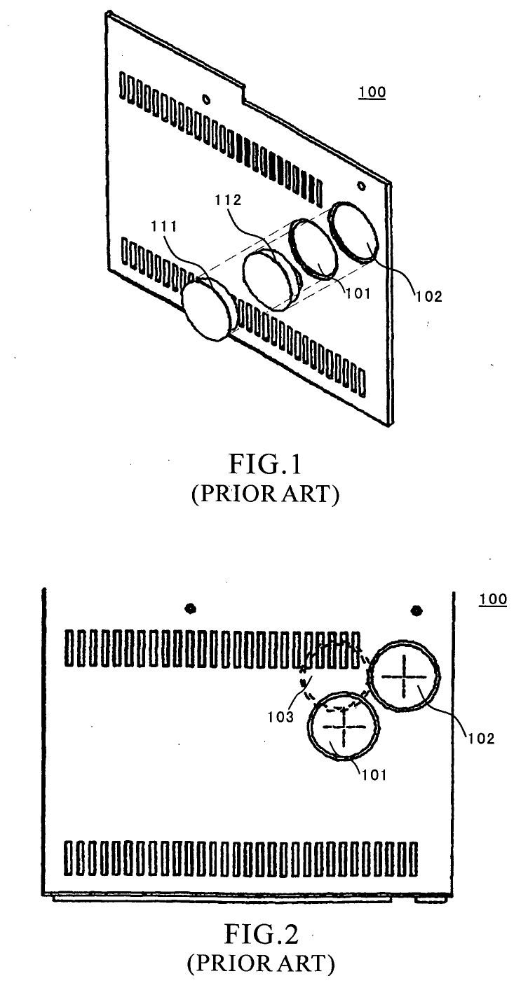

FIG. 2 is a front view of the housing panel shown in FIG. 1 with an additional opening provided;

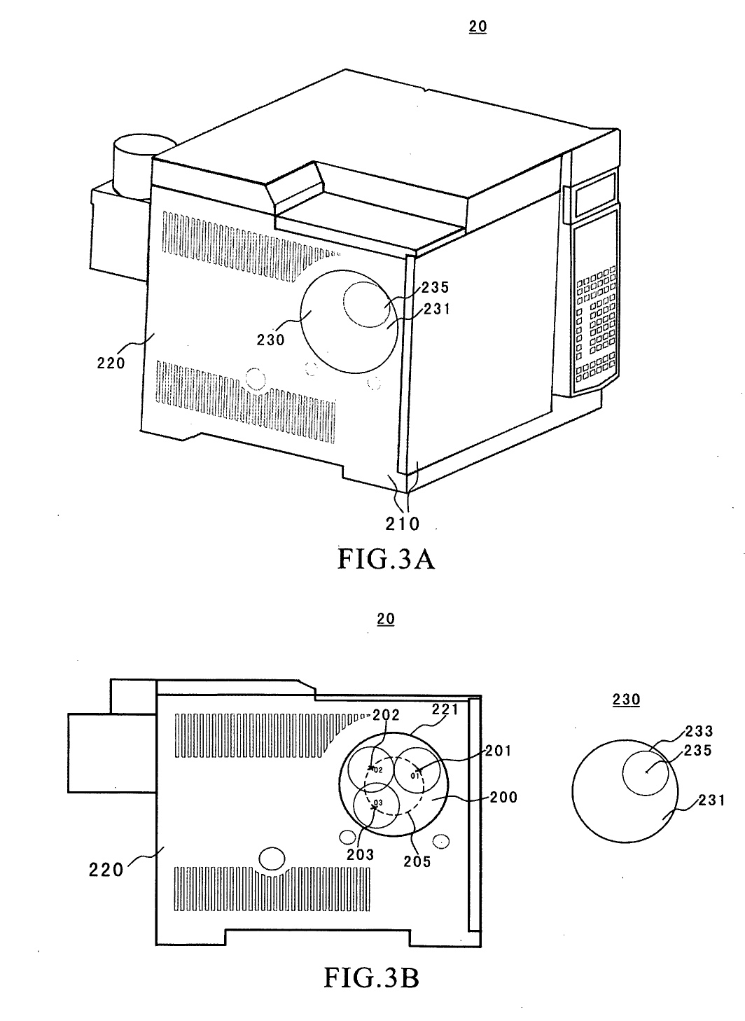

FIG. 3A is a perspective view of an analytical instrument with a housing and a plug structure in accordance with one embodiment of the present invention;

FIG. 3B is a front view of the analytical instrument of FIG. 3A with the plug structure separated from the housing;

FIG. 4 is a perspective view of the housing panel shown in FIG. 3A;

FIG. 5A to FIG. 5C respectively show the housing with the plug structure of FIG. 3A to FIG. 4 with one of the external-device interfaces of the analytical instrument being connected to an external device.

### DETAILED DESCRIPTION OF PREFERRED EMBODIMENTS

The embodiments of the present invention will be described with reference to the drawings.

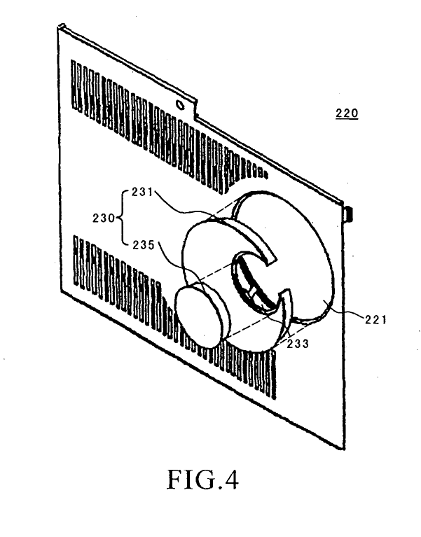

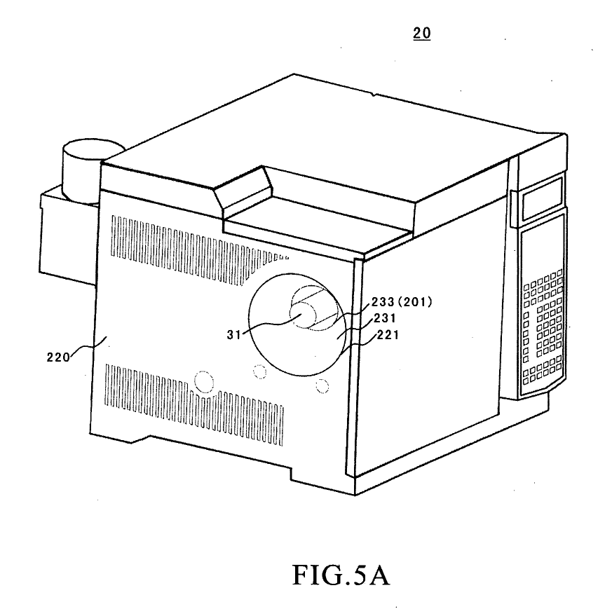

FIGS. 3A and 3B show an analytical instrument 20 that implements one embodiment of the present invention. In one embodiment, the analytical instrument is a GC (Gas Chromatography system). In another embodiment, the analytical instrument is a liquid chromatography system. In alternative embodiments, the analytical instrument can be other types of instruments that have external-device interfaces for interfacing with external devices.

FIG. 3A is a perspective view of the analytical instrument 20 with a bi-plug structure 230 that implements one embodiment of the present invention. FIG. 3A shows the bi-plug structure 230 mounted. FIG. 3B is a front view of the analytical instrument 20 with the bi-plug structure 230 removed.

The analytical instrument 20 shown in FIG. 3A and FIG. 3B includes an instrument body 200 for performing its analytical functions. If the analytical instrument 20 is a GC, then the instrument body 200 performs the function of separating a mixture of compounds.

The analytical instrument 20 also includes a housing 210 for housing the instrument body 200. The instrument body 200 includes three external-device interfaces 201, 202, and 203 for connection with external devices (not shown), such as mass spectrometers, for identifying each individual compound of the mixture by its unique mass spectrum. The housing 210 includes a housing panel 220 for covering the side of the instrument body 200 on which the external-device interfaces 201, 202, and 203 are provided.

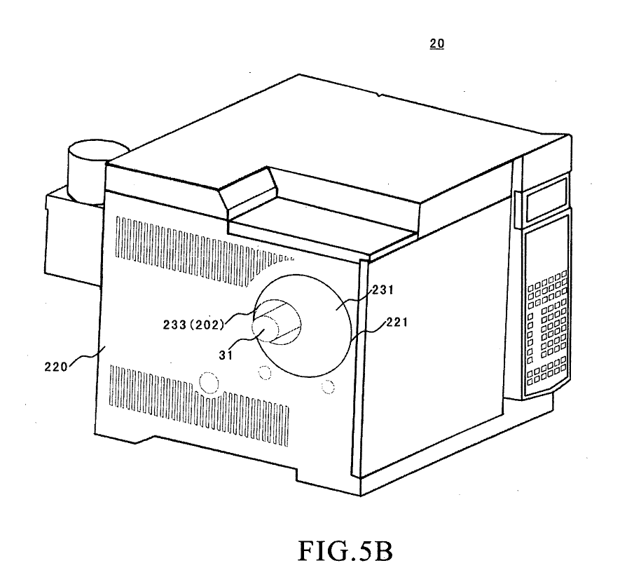

The detailed structure of the housing panel 220 is shown in FIG. 4. On the housing panel 220, a opening or hole 221 is provided to expose all of the external-device interfaces 201, 202, and 203 so that the external-device interfaces 201, 202 and 203 are accessible from the outside of the analytical instrument 20. For aesthetic reasons and for preventing contaminant from entering into the instrument body 200, the bi-plug structure 230 is provided to cover the opening 221. The bi-plug structure 230 includes a plug 231 and a plug 235 that is smaller in size than the plug 231. Thus, the plug 231 is hereinafter referred to as the big plug 231 and the plug 235 is hereinafter referred to as the small plug 235. The big plug 231 is rotatably fitted in the opening 221 formed on the housing panel 220 and has an opening or hole 233 through which an external device can be connected to its corresponding one of external-device interfaces 201, 202, and 203.

In one embodiment, each of the openings 221 and 233 is a circular opening. In another embodiment, each of the openings 221 and 233 can be other suitable shapes.

When there is no external-device connected to the analytical instrument 20, the opening 233 on the plug 231 is closed by the small plug 235 so that all the external-device interfaces 201, 202, and 203 are kept unexposed and the instrument body 200 is protected from receiving contaminants from outside, as shown in FIG. 3A.

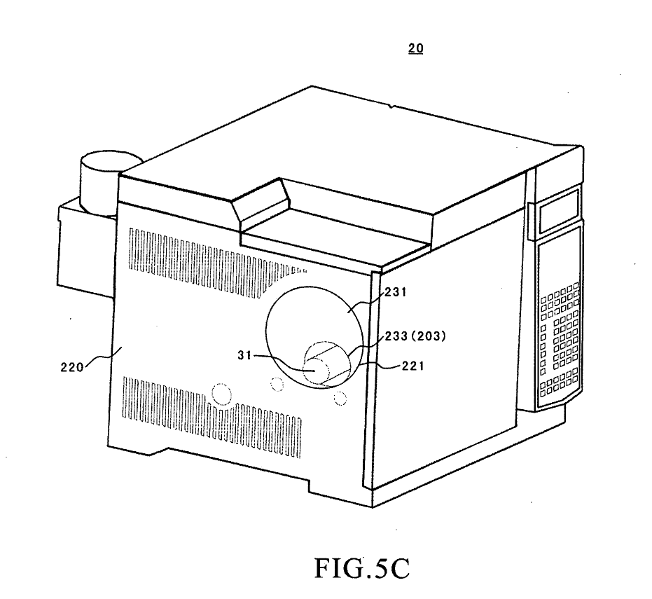

An external device can be connected to one of the external-device interfaces 201, 202, and 203 through the opening 233 by removing the small plug 235 from the opening 233 and rotating the big plug 231 to expose one of the external-device interfaces 201, 202, and 203. The detailed operation for connecting the external device to the analytical instrument 20 will be described below in connection with FIG. 5A˜FIG. 5C.

FIG. 5A˜FIG. 5C respectively show an external device (not shown) connected to one of the external-device interface 201, 202, or 203 via its connection member 31. As shown in FIG. 5A, when the external device is to be connected to the external-device interface 201, the small plug 235 is removed from the opening 233 on the big plug 231. The big plug 231 is rotated within the opening 221 until the intended external-device interface 201 is exposed through the opening 233, and then the connection member 31 is inserted through the opening 233 to connect to the intended external-device interface 201.

Thus, with the bi-plug structure 230 in accordance with one embodiment of the present invention, an external device can be connected to the external-device interface 201 through the opening 233 by simply removing the small plug 235 from the bi-plug structure 230 and rotating the big plug 231, while keeping the other external-device interfaces covered by the big plug 231 of the bi-plug structure 230 and from being exposed to the outside.

FIG. 5B and FIG. 5C respectively show an external device (not shown) connected to the external-device interface 202 or 203, respectively, through the opening 233 in the bi-plug structure 230.

In the embodiment described above, as shown in FIG. 3B, it is so designed that the opening 221 on the housing panel 220 for exposing all the external-device interfaces is substantially concentric with the circle 205(shown in dashed line) defined by the centers O1, O2 and O3 of the external-device interfaces 201, 202, and 203. Further the distance from the center of the opening 233 on the big plug 231 to the center of the big plug 231 is substantially identical with the radius of the circle 205. With such design, each external-device interface 201, 202, and 203 can be exposed through the opening 233 in the big plug 231 when rotating the big plug 231 mounted in the opening 221.

In the embodiment described above, the instrument 20 is shown to have three external-device interfaces 201, 202, and 203. It is understood that the number of external-device interfaces is not and should not be limited to three and it may be more or fewer than three depending on the number of external devices allowed to be connected to the instrument.

The description above is only intended to illustrate the present invention by examples, but not to limit the present invention.

What is claimed is:

1. An analytical instrument, comprising:
(a) an instrument body having a plurality of external-device interfaces for connection with external devices;
(b) a housing to cover the instrument body, wherein the housing includes a housing panel having a first opening that exposes all of the external-device interfaces;
(c) a plug structure, having
(i) a first plug rotatably fitted into the first opening and including a second opening that exposes one of the external-device interfaces;
(ii) a second plug having a size smaller than that of the first plug, wherein the second plug is removably fitted into the second opening to close the second opening when no external device is connected to any of the external-device interfaces, wherein when an external device is to connect to one of the external-device interfaces, the second plug is removed from the second opening and the first plug is rotated to expose the intended one of the external-device interface.

2. An analytical instrument according to claim 1, wherein the first opening on the housing panel is substantially concentric with the circle defined by the centers of all the external-device interfaces.

3. An analytical instrument according to claim 2, wherein the distance between the center of the second opening on the first plug and the center of the first plug is substantially same with the radius of the circle defined by the centers of all the external-device interfaces.

4. An analytical instrument according to claim 2, wherein the first and second plugs are circular.

5. An analytical instrument according to claim 1, wherein the instrument body includes a gas chromatograph system.

6. An analytical instrument according to claim 1, wherein the instrument body includes a liquid chromatograph system.

7. A housing panel structure for an analytical instrument, comprising:
(i) a housing panel having a first opening that exposes all of a plurality of external-device interfaces of the analytical instrument;
(ii) a plug structure, having
(a) a first plug rotatably fitted into the first opening and including a second opening that exposes one the external-device interfaces;
(b) a second plug having a size smaller than that of the first plug, wherein the second plug is removably fitted into the second opening to close the second opening when no external device is connected to any of the external-device interfaces, wherein when an external device is to connect to one of the external-device interfaces, the second plug is removed from the second opening and the first plug is rotated to expose the intended one of the external-device interface.

8. A housing panel structure for an analytical instrument according to claim 7, wherein when the housing panel structure is mounted on the analytical instrument, the first opening on the housing panel is substantially concentric with the circle defined by the centers of all the external-device interfaces.

9. A housing panel structure for an analytical instrument according to claim 8, wherein the distance between the center of the second opening on the first plug and the center of the first plug is substantially same with the radius of the circle defined by the centers of all the external-device interfaces.

10. An analytical instrument according to claim 9, wherein the first and second plugs are circular.
